(19) United States
(12) Patent Application Publication
(10) Pub. No.: US 2026/0029568 A1
(43) Pub. Date: Jan. 29, 2026

(54) OPTICAL STACK FOR LED ILLUMINATED DATA DISPLAY

(71) Applicant: Mnemonics, lnc., Melbourne, FL (US)

(72) Inventors: Mark Haines, Rockledge, FL (US); Patrick Livezey, Micco, FL (US); Wayne Marshall, Palm Bay, FL (US)

(21) Appl. No.: 19/289,802

(22) Filed: Aug. 4, 2025

Related U.S. Application Data
(60) Provisional application No. 63/655,633, filed on Jun. 4, 2024.

(51) Int. Cl. F21V 8/00

(52) U.S. Cl. CPC G02B 6/006

(57) ABSTRACT

An optical stack for use with an illuminated data display. The stack comprises the following layers: an opaque layer defining one or more openings therein, a diffuser layer disposed overlying the openings, a fiber optic glass layer overlying the diffuser layer, and transparent protective layer overlying the fiber optic glass layer. An illumination source is disposed within the one or more openings, and illumination from the illumination source propagates from the illumination source through the diffuser layer, through the fiber optic layer, and through the protective layer.

### CROSS REFERENCE TO RELATED APPLICATIONS

The present application claims priority under 35 U.S.C. 119(e) to the provisional patent application filed on Jun. 4, 2024 and assigned application No. 63/655,633 (Attorney Docket Number 11067-016). The contents of that application are incorporated herein.

### FIELD OF THE INVENTION

The present invention relates to an LED (light emitting diode) illuminated display.

### BACKGROUND OF THE INVENTION

Display devices are used in a variety of configurations and layouts to provide information to a user. A single lit LED advises the user that a device is operative, while the unlit or off LED indicates the device is “off”. Also, multicolor LEDs can provide additional information to the user, beyond a simple “on” or “off” indication.

A plurality of LEDs can be placed in proximate relation to form a chain or string of LEDs, again, to convey information to the user. And the chain or string can form a segment of a number or letter. Several such strings appropriately placed and simultaneously illuminated can form a letter or number.

When the LEDs are disposed in a matrix configuration, a light blocking dam is placed around each LED to prevent light diffusion from an illuminated LED to a non-illuminated LED. However, under certain ambient light conditions and notwithstanding use of a light dam, an “off” LED may appear to be “on” and thereby convey incorrect information to the user.

For example, a device or system may be controlled according to the position of one or more rocker switches or rocker buttons, each controlling a different device or system function. If the rocker switches are closely spaced, light from an illuminated or “on” rocker button may bleed into an adjacent “off” rocker button, likely confusing the user as to the status of the device.

To avoid this situation, light seals or light dams are placed around each rocker switch to prevent or at least limit the bleeding of light between the switches.

Electronic devices such as keyboards, keypads, display devices, phones, signage, and other devices are oftentimes lighted to improve the visibility, ergonomics, and general appearance. Current lighting techniques for these devices require multiple physical layers to generate, guide, and deliver the light to the illuminated area. These layers typically include a lighting panel layer, a lighting circuit layer, and an electronic layer for switches and other electronic components. Frequently, the devices are illuminated by an assembly of closely-spaced LEDs and light bleed through issues, as discussed above, can arise. While it is important to prevent light bleed through, it is also critical to ensure that sufficient light from the light source propagates to the illuminated device. Moreover, interference between the light emitted from different LEDs reduces intensity of the emitted light. Hence, a new designed LED device that overcomes aforementioned deficiencies is required.

### BRIEF DESCRIPTION OF THE DRAWINGS

Various other objects, features and attendant advantages of the present invention will become fully appreciated as they become better understood when considered in conjunction with the accompanying drawings, in which like reference characters designate the same or similar parts throughout the several views, and wherein:

FIGS. 1 and 2 each illustrate an illuminated display attached to a printed circuit board.

FIG. 3 illustrates an optical stack of the present invention.

FIGS. 4 and 5 each illustrate an illuminated display.

FIGS. 6-9 each illustrate an illuminated display comprising a dial face and numerals.

FIG. 10 illustrates another embodiment of the optical stack of the present invention.

FIG. 11 illustrates a populated printed circuit board and a display according to the present invention.

FIG. 12 illustrates an illuminated display according to the present invention within an enclosure.

### DETAILED DESCRIPTION OF THE INVENTION

The present invention relates to a stack (sometimes referred to as an optical stack) of material layers disposed above light sources, such as LEDs, with each layer modifying or redirecting the LED light (or reducing the effects of ambient light) as it propagates from the source.

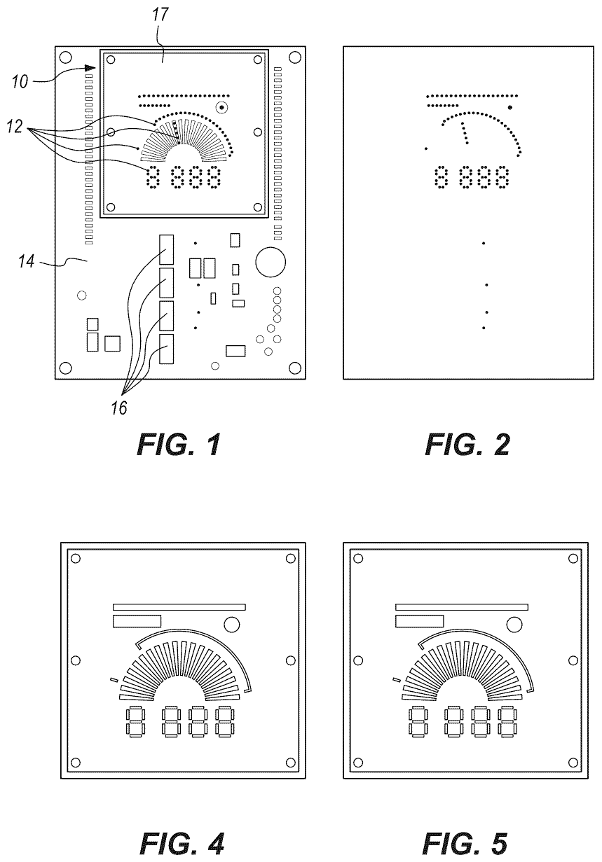

A display 10 comprising a plurality of LEDs 12 is illustrated in FIG. 1. The display is electronically and physically connected to an electronic printed circuit board (PCB) 14. Components 16 on the PCB 14 control the on/off state and brightness of the individual LEDs. The ON or OFF state of the LEDs convey information to a human data consumer or to an equipment operator, such as an aircraft pilot or vehicle operator.

The bare PCB 14 when populated with the display 10 and the components 16, is configured into a functioning circuit card assembly (CCA). Some end-users might consider the inventive optical stack, further described and claimed herein, to be an element of the CCA. However, for clarity, here the optical stack is defined as and considered a separate sub-assembly that is attached to or placed proximate a populated PCB. As will be further described herein, a black light dam 17 (see FIG. 1) as well as the LEDs are considered elements of the optical stack.

The inventive optical stack, as described and claimed herein, clearly requires circuits and components to control the LEDs, as in known by those skilled in the art. However, regardless of how the LEDs are powered or controlled, the LEDs are typically mounted on the printed circuit board and received within openings of the optical stack, that is within openings of the lowest layer of the optical stack, which is the opaque light dam layer. The optical stack additionally includes elements or layered elements installed above opaque light dam layer and the LEDs, as described herein. The optical stack includes the light dam 17, which is also shown in FIG. 1.

The PCB includes LED light sources that are located where illumination is required in the final assembly. In the FIG. 1 structure, the multiple LEDs create “dots of light” or “points of light” that may fail to provide a continuous illuminated segment, e.g., a segment of a numeral or of a letter, that can be easily interpreted by a user, albeit the segment comprises multiple individual LEDs.

It is preferrable that the individual LED light sources 12 in FIG. 1 provide even and uniform illumination through an opening in the light dam 17 that surrounds the LEDs, rather than appear as several individual spots of light. The opening in the light dam defines a segment shape (a segment of a letter or numeral, for example) with the LEDs providing illumination through that opening, but in the prior art the opening is not uniformly illuminated due to the “point” source LEDs. In one application a pair or multiple closely-spaced LEDs are configured in the shape of a light bar, such as for a seven-segment display, with all LEDs of the segment controlled together to light the segment. Controlling the LEDs associated with multiple segments can then display more complex shapes, such as a numeral.

In the present invention, all LEDs associated with a segment or segment shape are controlled as a single unit. Thus, the LEDs forming a segment are either all ON or all OFF. If the brightness of the segment illumination is controllable, all LEDs in that segment are controlled to the same brightness when illuminated.

Thus, while the use of many small LED light sources allows a relatively uniform spread of light over the illuminated segment, the spotty or “dot” nature of the combined total illumination is unfortunately very apparent to the user, as can be seen in FIG. 1.

The objects in FIG. 2 are identical to those in FIG. 1, but the exposure duration in FIG. 2 is less than the exposure duration of FIG. 1 to better illustrate the individual LEDs. But here too, the spotty appearance of the lighted segments is obvious and objectionable.

The spotty nature of the light sources in both FIGS. 1 and 2 suggests the need to further refine components associated with the illumination sources to create a more uniform and continuous illumination for each LED-based segment. It is an objective of the present invention to provide that uniform and continuous illumination.

Thus, the optical stack of the present invention eliminates the “spotty nature” or “dots of light” of the illumination sources illustrated in FIGS. 1 and 2. Additionally, the inventive optical stack enhances contrast and readability, and is physically configured so that the stack can be sealed to protect the stack components from the external environment.

To achieve these desired visual characteristics, the inventors have developed the optical stack comprising multiple material layers for overlaying the PCB and the electronic components mounted thereon, and the LEDs electrically and physically attached to the PCB. The material layers are stacked in a prescribed order and installed on or above the PCB after the PCB has been populated with the LEDs and the electronic components.

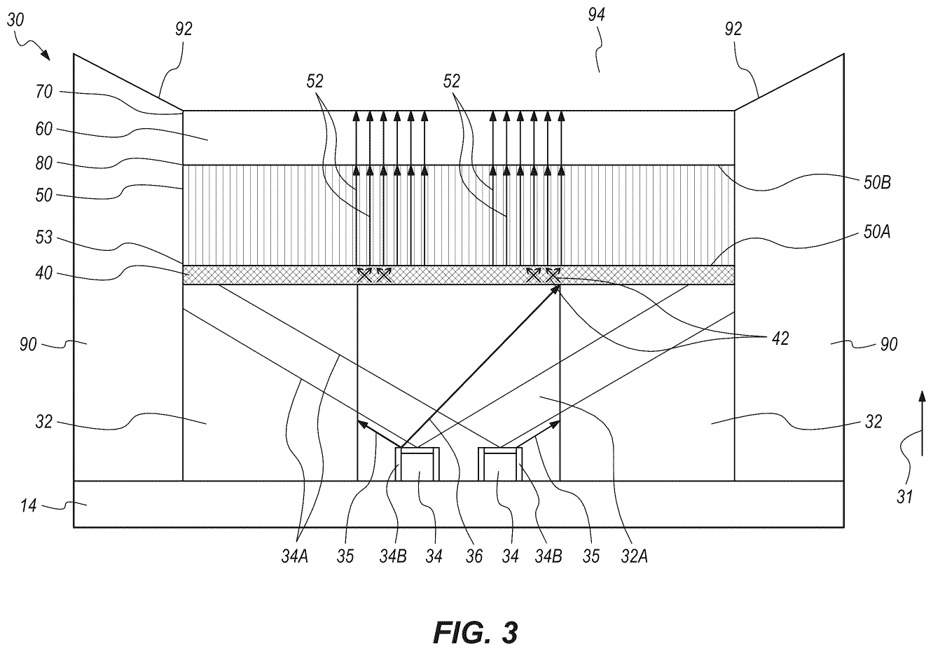

The optical stack is schematically illustrated in FIG. 3 and identified by reference numeral 30. The present invention thus comprises this optical stack of elements and its layered construction.

The first four components (proceeding upward from the LEDs disposed below the optical stack) are preferred to achieve the desired functionality and represent a basic design for the optical stack. These basic elements comprise (the parenthetical reference numerals refer to FIG. 3):
1. The light dam (reference numeral 32 in FIG. 3)
2. The diffuser panel (reference numeral 40 in FIG. 3)
3. The fiber-optic (FO) glass panel (reference numeral 50 in FIG. 3)
4. A durable protective layer (reference numeral 60 in FIG. 3), to avoid damage to the more delicate FO glass

Other layers are optional to enhance the basic design and can be individually added to create a different optical stack configuration with certain beneficial properties for use in different environments. Such “optional” layers are further described below.

Generally, the inventive optical stack is operative with an electronics system and is embedded in an enclosure (e.g., an instrument panel or a chassis) of that system. To view the LEDs, a top surface of the optical stack comprises a durable window that can be viewed through an opening in the enclosure. Embedding the optical stack in the enclosure protects the electronics from the environmental effects while allowing an operator to view the LEDs.

For use in a rugged operational environment, that top-surface window comprises a durable transparent sheet (for example, plexiglass, acrylic, or a clear glass) that permits viewing of the LEDs. This window layer, which is considered one element of the optical stack of the present invention, is sealed to a front or top panel of the enclosure using sealant appropriate for the intended operational environment. Each material layer of the optical stack can also be sealed to protect the optical stack layers and the electronic components of the PCB on which the optical stack is disposed. The characteristics of these seals and the characteristics of the enclosure are beyond the scope of the inventive optical stack described herein.

Optionally, the transparent window layer may include one or more of an antireflective coating, and an absorptive/filtered/lossy/tinted glass

The optical stack provides uniform brightness (i.e., luminance) across each illuminated segment.

With reference to FIG. 3, an optical stack 30 comprises a light dam 32. LEDs 34 are received within an opening 32A (also referred to as a chamber or well) defined in the light dam 32 and are electrically connected to the PCB 14 that controls and supplies power to the LEDs. A single or a plurality (two or more) LEDs (only two LEDs 34 shown in FIG. 3) emit light upwardly (in the direction of arrowhead 31) through that opening 32A.

A shape of the opening, when viewed from above, may form a segment of a numeral (such as a segment of the numeral “8”) or may form a pointer, a needle, tick marks (dial graduations) on a dial face, or any of meaningful graphical shape. The opening shape can also represent a graphics symbol, a complete illuminated word (e.g., “STOP”), or individual segments in a numeral digit, such as the segments in a conventional 7-segment display.

FIG. 3 depicts only a single openings 32A with two LEDs 34 disposed therein, but those skilled in the art recognize that several such openings and multiple LEDs are typically required to convey information to a user of the electronics system.

In one embodiment a width of the opening 32A is about 2.54 mm (extending to several inches in other embodiments) and the height of the light dam is about 2.5 mm. Cones 34A extending vertically from each LED 34 represent the viewing angle for the associated LED. LEDs are typically specified with a viewing angle; LEDs with a lens built into the cover are as narrow as 30 degrees (+/−15), while conventional solid plastic package LED may offer a viewing angle of about 140-150 degrees. These dimensions are merely exemplary. In any case, the height of the light dam (also referred as an opaque material layer) should be such that the top of the opening 32A is fully illuminated by the specified beamwidth (viewing angle) of the light from the nearest LED. However, the only detrimental effect of an excessive height is the loss of light power as more of the emitted light is absorbed by walls of the light dam instead of propagating out from the opening or well.

LED metal contacts, designated with reference numeral 34B, on each side surface of each LED, are soldered to solder pads on the PCB 14.

The light dam 32 confines the LED light within the opening 32A. As depicted, light rays 35 emitted from the LEDs 34 strike the boundary walls of the opening 32A and do not propagate up through the optical stack. Light ray 36 represents the lowest angle at which light rays emitted from an LED will propagate up through the stack and light rays at higher angles will also propagate up the optical stack.

The openings 32A within the light dam define the size and shape of the illuminated segments of a numeral or dial, for example. In one embodiment, an enhanced definition of a segment boundary can be provided by a silkscreen layer, as explained below.

A material of the light dam 32 comprises an opaque plastic material. Preferably the light dam is 3D printed, but can also be produced by extrusion, injection molding, or machined.

The visible segment openings can be turned ON or OFF (specifically the LEDs forming an illuminated segment can be turned ON or OFF) to convey information to the end user. It is therefore critical that LED-supplied light illuminating an “ON” segment, as defined by a light dam opening, does not leak light into an “OFF” segment opening within the light dam. Thus, the enclosure is referred to as a “dam” because the dam stops the flow of light between proximate segments openings.

It is clear that some horizontal spreading of the light is essential to achieve the desired uniformity across the display segments and permit easy recognition of the LED-based light segments. Although some light diffusion (spreading) is required to uniformly illuminate a segment, blurring across segment boundaries must be avoided. A diffuser panel layer 40 (see FIG. 3) accomplishes those objectives by scrambling the light received from the LEDs 34. Arrowheads 42 indicate diffusion or spreading of the light rays from the LEDs 34. But this spreading is terminated as the light enters FO glass layer 50, which allows light to propagate only perpendicular to the surfaces of the FO glass. See arrowheads 52.

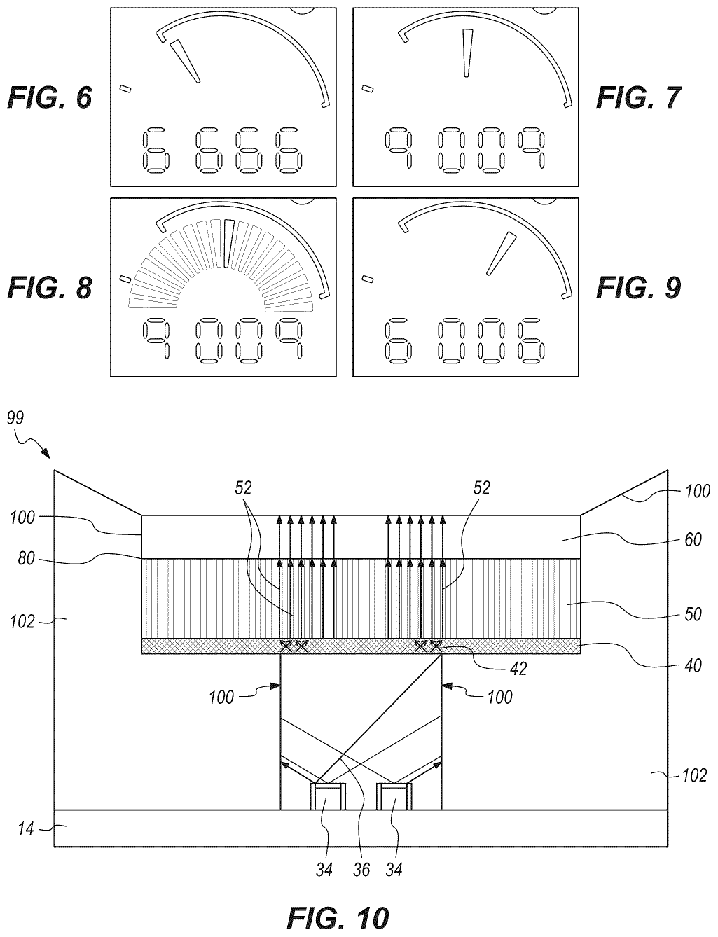

In one embodiment the diffuser panel 40 is a relatively thin sheet of acrylic, where “thin” is defined as less than about half (10% to 50%) of the finest resolution of horizontal distance between open segments in the light dam. This thickness limits the spillover of light from one segment to an adjacent segment. The diffuser panel scatters light and helps fill in the dark space between the LED “dots” within a segment. Thus, turning the spotty segment of FIGS. 1 and 2 into the uniformly filled segments shown in FIGS. 6, 7, 8 and 9.

Although the dark spaces within a segment must be filled in, blurring of light from one segment into a neighboring segment must be avoided. Blurring is avoided because the diffuser material is sufficiently thin that it does not propagate light horizontally into a proximate segment. And as set forth above, the diffuser thickness should therefore by about 10% to 50% of smallest gap between segments. As shown in FIG. 3, the diffuser panel tends to change or scramble the direction of light entering the stack layer above the diffuser panel. See arrowheads 42.

The fiber-optic (FO) glass layer, panel, or faceplate 50 imparts an opposite effect on the propagating light compared to the diffuser panel. The layer 50 captures light that enters a bottom surface 50A and transmits it only vertically (i.e., no horizontal spreading) to the top surface 50B of the FO glass panel. This is due to formation of the FO glass layer by fusing bundles of thousands of vertical individual glass fibers, then cutting across the fibers into sheets of a desired thickness. Light entering any of these fibers must stay within the fiber until it exits the far end, which in the present situation is the opposite surface from where the light entered. Also, there is very little loss of light amplitude within the FO glass layer 50, and therefore any desired thickness is acceptable, so long as the thickness is many times (i.e., at least 10×) the diameter of each fiber.

Thus, the diffuser layer 40 and the fiber optic layer 50 cooperate to transform the point source LED light into a uniformly-filled light segment that appears on a top surface 50B of the fiber-optic glass layer 50, and not down in a hole/well in the light dam 32. The effect is nearly magical, since the angle the light rays leave at the top surface of the optical layer 50 is the same angle as the light entered the optical layer. The three-dimensional effect (due to the parallax effect of the observer's eyes) is that the image appears at the top surface of the glass layer 50 and not down in well of the optical stack light dam.

To reduce the effects of strong ambient light entering the top surface of the stack, the top protective layer 60 of the optical stack (setting atop the FO glass layer 50) may be a darkened/tinted glass material. In this case the layer 60 comprises a durable tinted glass that reduces light transmission by at least 50%. The optical bonding layer 80 (see FIG. 3) for bonding the FO glass layer 50 and the protective layer 60 is described in detail below.

It may appear counter-intuitive to attenuate light that makes display features visible, but it must be appreciated that if the layer 60 is tinted, that feature also attenuates ambient light (e.g., ambient daylight) transmitted down toward the light dam 32 by 50% (or more) and 50% (or more) again as the light propagates upwardly, after scattering by the diffuser layer 40, the top and bottom surfaces of the FO glass layer 50, surfaces of the light dam 32, and surfaces of the circuit board 14 and electronic components mounted on the circuit board.

Use of tinted glass for the layer 60 depends on the maximum brightness required for the display. Higher losses or attenuation (i.e., 10% transmissivity glass which is 90% lossy) provided by a tinted layer results in more contrast relative to reflected ambient light. Thus, the optimal design suggests maximum attenuation so long as all other performance specifications are acceptable. However, if the ambient light environment is favorable, lower attenuation losses are acceptable, which means less power consumed to illuminate the LEDs.

In another embodiment, the protective layer 60 may additionally include an anti-reflective coating (that is, typically multi-layer films). Use or non-use of the anti-reflective coating is independent of the use or non-use of the tinted material described above. The tinting material reduces the light reflected back up from the various lower layer surfaces and from the diffuser layer 40. While the anti-reflective coating is primarily concerned with light reflecting from the very top surface of the stack, i.e., glare.

Generally, a thickness of the protective layer 60 is determined by the operational environment of the optical stack and a strength of the material of the protective layer.

Additionally, optically bonding the surfaces 50A and 50B (of the FO glass layer 50) to the adjacent surface further reduces reflections from air-glass interfaces by replacing the air with a material that has an intermediate refractive index. With tinted glass on the order of 90% loss, this is a very powerful technique because, although only 10% of the LED segment brightness comes through, only 1% of the reflected ambient light (i.e., 1% relative to the same configuration with no tinting) returns to the viewer and competes with the desired LED segment light.

Furthermore, by using high-brightness and/or high-efficiency LED light sources the brightness is increased to compensate for the one-way losses of the LED light as it propagates up through the optical stack. Therefore, compared to no tinting in the layer 60, the display provides the same segment brightness, but has 99% less interfering light.

One embodiment of the present invention comprises an anti-reflective (A/R) layer or coating 70. See FIG. 3. In one embodiment, a top surface of the protective layer 60 is treated with an additive coating(s) to form the anti-reflective layer 70, which comprises thin film layers that block the reflection of specific wavelengths. Theoretically, a single layer of film can completely cancel reflection at one wavelength (e.g., green LED light) if viewed perpendicular to the surface of the glass. However, to effectively cancel at other viewing angles and at other wavelengths, many layers of various materials and thicknesses are typically needed. Applying multiple layers is referred to as a “multi-layer optical coating” or “multi-coated optics” and is a standard treatment for camera lenses and other optical systems.

As can now be appreciated, the use of various top layer materials and coatings allow for canceling problematic wavelengths or cancelling light rays from various directions.

The optical stack can also include features or components (not shown) that secure or align one or more of the optical layers above the light dam. An early light dam embodiment illustrated in FIG. 4 was produced using an FDM (fused deposition modeling) 3D printer, but problems with retaining the shape of the smaller openings developed during the printing process.

The inventors then determined that using an SLA (stereo lithography) 3D printer provided cleaner features in the light dam. See FIG. 5.

Another embodiment of the present invention comprises an optical bonding layer 80 shown in FIG. 3. For glass-to-glass bonding, various adhesives are available that match the dielectric properties of glass, so that when two glass layers are bonded together (that is, flat-surface-to-flat-surface) the air gap between layers is eliminated and the bonded surfaces do not reflect a significant portion of the light striking the bonded surfaces. This adhesive bonding therefore increases daylight readability by further reducing the amount of ambient light that competes with the desired light from the LEDs 34 of FIG. 3.

As an additional benefit, the bonded assembly is stronger than either the FO glass 50 or the protective layer 60 alone, which allows for the use of a very thin protective layer 60, such as Corning® Willow® Glass (a registered trademark of Corning Incorporated of One Riverfront Plaza, Corning, NY 14831) or Corning® Gorilla® Glass (also a registered trademark of Corning Incorporated of One Riverfront Plaza, Corning, NY 14831)’

FIG. 3 further illustrates clear acrylic material 90 with opaque surfaces 92 (typically painted) on each side surface of the optical stack 30. The opaque material confines the light to the optical stack 30 while the clear acrylic material allows for illumination of labels defined on the surface of the housing by openings in the opaque surface. Alternately, if label lighting is not needed on the panel, the housing material can be either painted metal or a solid opaque polymer such as Delrin. The design of the housing is beyond the scope of the current invention, but is mentioned as the easiest way to eliminate light leakage from side surfaces of the inventive optical stack.

Note also a recessed viewing opening 94. Typically, the optical stack is embedded in an instrument panel or chassis. The recess 94 helps to protect the top elements of the optical stack from wear and tear from rubbing, handling, and touching; however, the protective layer 60 needs to provide the required durability for the optical stack.

In yet another embodiment, the present invention comprises an opaque bottom silkscreen layer applied to regions of the bottom surface of the protective layer 60. The silkscreen provides better definitions of the illuminated segments (LEDs) against the background of the display. However, since the silkscreen cannot cover any LEDs or the illuminated segments formed by the LEDs, the silkscreen does not suppress reflections from unlit segments. See the unwanted illumination of unlit segments in FIG. 8 caused by ambient light. However, the use of silkscreen layer is a less expensive approach than tinting and use of the antireflective coating, so in less challenging ambient light environments the increased contrast may be desirable.

In still yet another embodiment, a top opaque silkscreen layer can be applied to the top surface of the protective layer 60. The inventors have determined that the use of a silkscreen on the top surface of the antireflective protective layer (i.e., the protective layer 60 with an applied anti-reflective coating) is best suited for displays that are not used in bright ambient light, and where increased definition of the illuminated segments/LEDs is aesthetically pleasing.

FIGS. 6-9 illustrate varying contrast levels for different optical stacks. Strong ambient light is present (about 2500 fc) in each figure. The same diffuser layer 40 was used in the embodiments of FIGS. 6-9.

In FIG. 6 the FO glass layer 50 scatters too much ambient light and degrades the contrast of the lit segments.

There are differences in the reflectivity of various kinds of FO glass, and the image in FIG. 7 illustrates that under the same ambient lighting conditions, a less reflective FO layer 50 provides a much darker background, making it superior for daylight readable applications.

The FO glass in FIG. 6 had a rough texture on one surface in an attempt to provide a “built-in” diffuser. But better results were obtained with the smooth surface FO glass and a separate diffuser layer as in FIG. 7.

The dark region over the numbers in FIGS. 7-9 is tinted glass for showing the effect of reduced reflection of ambient light.

The FIG. 8 sample includes a black silkscreen applied to the bottom surface of the clear protective layer 60, which enhances the lit segments, but leaves the unlit segments too bright (i.e., about the same brightness level as in FIG. 6). These unlit segments, since they cannot be covered by silkscreen material, may be brighter than the background in strong ambient light conditions and thus may be perceived as being lit, which would be misleading to a user/operator.

By using tinted glass as the protective layer 60, (see FIG. 9) the unlit segments completely disappear by attenuating the ambient light.

Optical bonding and A/R coatings are not shown in any of the FIGS. 6-9, but can be added to improve the daylight readability even further. Optical bonding is applied between layers 40 and 50 (see layer 53 in FIG. 3), and between layers 50 and 60 (see layer 80 in FIG. 3). The antireflective coating is applied to a top surface of the layer 60, where layer 70 represents the antireflective coating layer.

An alternative configuration of an optical stack 99 is illustrated in FIG. 10. In this embodiment the light dam functionality is provided by cavities in a larger component, with the cavities bounded by opaque surface material 100 bounding a clear or translucent material of a panel 102. The larger component may comprise the entire display panel fabricated as one piece. Thus, the light dam is an element of that larger component and surrounds the LEDs. The cavities may be formed by fabricating (e.g., machining or 3D printing) the segment cavities into that material. If the material in which the segment cavities are formed in is not opaque, then the inner walls of the segment cavities must be made opaque by applying a coating or paint to create the opaque surface 100.

So, with or without an opaque surface coating, the light dam is simply the opaque walls of the segment cavities. In the embodiment of FIG. 10, the light dam functionality is integrated into the larger structure of the assembly or housing into which the display has been integrated, which is more practical with improvements in 3D printing.

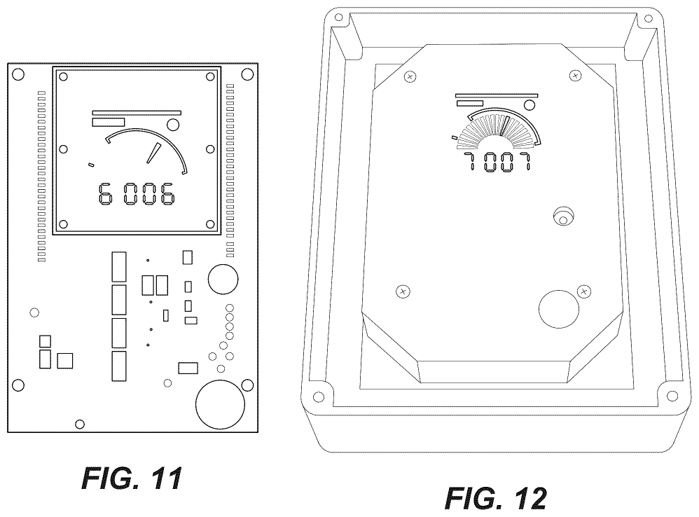

FIG. 11 depicts a populated printed circuit board and a display according to the present invention mounted on the PCB. The display is controlled by a processor on the printed circuit board. The resulting assembly can be installed in an enclosure as depicted in FIG. 12. However, as described elsewhere, the enclosure is not considered an element of the invention, but is depicted merely as one application for the optical stack of the present invention.

FIGS. 3 and 10 illustrate light propagation through the optical stack for a single segment of a display. The segment is surrounded by opaque walls that can be formed within a light dam. But typically, the light dam defines one or many such segments and thus FIGS. 3 and 10 illustrate simplified versions of more typical implementations of the invention.

What is claimed is:

1. An optical stack for use with an illuminated data display, comprising:
in a stacked relationship:
an opaque layer defining one or more openings therein;
a diffuser layer disposed overlying the openings;
a fiber optic glass layer overlying the diffuser layer;
a transparent protective layer overlying the fiber optic glass layer; and
wherein an illumination source is disposed within the one or more openings, and
wherein illumination from the illumination source propagates from the illumination source through the diffuser layer, through the fiber optic layer, and through the protective layer.

2. The optical stack of claim 1, wherein the illumination source comprises one or more light emitting diodes.

3. The optical stack of claim 2, wherein the one more light emitting diodes are electrically connected to a printed circuit board, and wherein the opaque layer is attached to or in proximate relation to the printed circuit board.

4. The optical stack of claim 1, wherein one of the one or more openings defines a segment of a number or of a letter, or defines a pointer, a needle, tick marks, or a graphical shape.

5. The optical stack of claim 4, wherein the optical stack provides uniform brightness across the segment.

6. The optical stack of claim 4, wherein the one or more openings define a plurality of segments, and wherein a thickness of the diffuser layer is about 10% to about 50% of a smallest distance between two segments.

7. The optical stack of claim 1, wherein the optical stack and the illumination source are disposed in an enclosure, such that the transparent protective layer is disposed within an opening in the enclosure and light from the illumination source is visible through the transparent protective layer.

8. The optical stack of claim 7, wherein the optical stack is recessed below a surface of the enclosure such that the transparent protective layer is below the surface of the enclosure.

9. The optical stack of claim 1, wherein a material of the transparent protective layer comprises plexiglass, acrylic or glass.

10. The optical stack of claim 8, further comprising a seal material disposed between the enclosure and the transparent protective layer.

11. The optical stack of claim 1, wherein the transparent protective layer comprises one or more of an antireflective coating, a light absorptive coating, a light filter coating, and a tint coating.

12. The optical stack of claim 11, wherein the light absorptive coating, the light filter coating, and the tint coating reduce the amount of illumination from the illumination source that passes through the transparent protective layer.

13. The optical stack of claim 12, wherein the tint coating reduces light transmission by about 50%.

14. The optical stack of claim 12, wherein an amount of light attenuation provided by the tint coating is determined based on a required brightness of light produced by the illumination source and exiting the protective layer.

15. The optical stack of claim 1, wherein light from the illumination source is spread or diffused as the light propagates through the diffuser layer.

16. The optical stack of claim 1, wherein light from the diffuser layer propagates substantially vertically through the fiber optic glass layer.

17. The optical stack of claim 1, wherein a thickness of the diffuser layer is determined such that light from one illumination source that illuminates a first segment does not propagate horizontally to illuminate a proximate second segment.

18. The optical stack of claim 1, wherein the fiber optic glass layer comprises a fused plurality of vertically aligned glass fibers, wherein light from the diffuser layer enters a bottom surface of the plurality of glass fibers and exits a top surface of the plurality of glass fibers.

19. The optical stack of claim 1, further comprising a first optical bonding material for bonding an upper surface of the fiber optic glass layer to the transparent protective layer, and a second optical bonding material for bonding a lower surface of the fiber optic glass layer to the diffuser layer.

20. The optical stack of claim 1, further comprising a coating layer on the transparent protective layer for attenuating predetermined wavelengths of light.

21. The optical stack of claim 1, further comprising a coating layer on the transparent protective layer for attenuating light striking the protective layer from a predetermined direction.

22. The optical stack of claim 1, wherein a thickness of the opaque layer is about 2.5 mm.

23. The optical stack of claim 1, further comprising a silkscreen layer disposed either or both above and below the transparent protective layer.

24. An optical stack for use with an illuminated data display, comprising:
in a stacked relationship;
a clear or translucent material defining one or more cavities therein, with each cavity bounded by an opaque material layer;
a diffuser layer disposed overlying the one or more cavities;
a fiber optic glass layer overlying the diffuser layer;
a transparent protective layer overlying the fiber optic glass layer; and
wherein an illumination source is disposed within the one or more openings, and wherein illumination from the illumination source propagates from the illumination source through the diffuser layer, through the fiber optic layer, and through the protective layer.
